(19) United States
(12) Patent Application Publication
(10) Pub. No.: US 2026/0350996 A1
(43) Pub. Date: Nov. 5, 2026

(54) AUTOMATED SAFETY MANAGEMENT IN ENVIRONMENT

(71) Applicant: HACK PARTNERS LIMITED, Devizes (GB)

(72) Inventors: Shayan TAHERIAN, London (GB); Sebastian KAY, London (GB); Harvey STEDMAN, London (GB); Haydon BARTLETT-TASKER, Tonbridge (GB)

(73) Assignee: HACK PARTNERS LIMITED, Devizes (GB)

(21) Appl. No.: 19/119,852

(22) PCT Filed: Oct. 11, 2023
(86) PCT No.: PCT/IB2023/060217

§ 371 Date: Apr. 10, 2025

(30) Foreign Application Priority Data
Oct. 11, 2022 (GB) 2214976.9

(51) Int. Cl. G06V 20/52; B61L 23/04; G06V 10/12; G06V 10/25; G06V 10/26; G06V 10/764; G06V 10/774; G06V 10/82; G06V 20/64; G06V 20/70

(52) U.S. Cl. CPC G06V 20/52; B61L 23/04; G06V 10/12; G06V 10/25; G06V 10/26; G06V 10/764; G06V 20/64; G06V 20/70; G06V 10/774; G06V 10/82; G06V 2201/07

(57) ABSTRACT

A method for automated safety management in an environment. The method includes receiving monitored data from a monitoring apparatus, wherein the monitored data includes one or more image frames associated with the environment, generating a plurality of point clouds associated with the environment by utilizing the one or more image frames in the monitored data, detecting one or more objects from the plurality of point clouds based on predefined notations, detecting at least one target object from the one or more objects based on at least a risk criterion and generating a command signal indicative of a risk event associated with the at least one target object.

### TECHNICAL FIELD

This invention relates to safety management methods. In particular, though not exclusively, this invention relates to a method for automated safety management in an environment and an automated safety management system.

### BACKGROUND

Maintenance of safety standards and railway assets is a key component in the railway industry. The maintenance of safety standards and the railway assets is performed by railway personnel such as inspection or maintenance workers, to ensure that the entire railway infrastructure is safe and reliable. Typically, this includes carrying out inspections related to signalling and power supplies, railway tracks and bridges, embankments, fences, level crossings, cess paths and the wider railway environment. In this regard, intelligent software can be used to collect and analyse usage data so that predictive and preventative management and maintenance can be carried out rather than reactive repairs.

Conventionally, manual inspection methods are used to inspect the railway environment. Herein, the manual inspections involve the inspection or maintenance workers walking along the railway tracks or riding in train carriages to spot defects or violations across a range of the railway assets in the railway environment. The defects may be at least one: scrap rail, unwanted vegetation, damaged and/or obscured signs, obstructing objects, damaged and/or obscured signals, graffiti and overhead line assets. However, said manual inspections are time consuming, unsafe, and inaccurate. Moreover, maintenance workers often use cellular devices comprising a camera and pen and paper to record and log data and manually review the data, leading to numerous inaccuracies.

Therefore, in light of the foregoing discussion, there exists a need to overcome the aforementioned drawbacks associated with safety management methods and systems and provide an improved, secure and dynamic safety management system and/or method.

### SUMMARY OF THE INVENTION

In a first aspect, the invention provides a method for automated safety management in an environment. Typically, for safe and secure functioning of any working environment, proper and effective safety management is required to render the working environment safe for implementation via users and/or working personnel. The term “environment” as used herein refers to an area or a zone managed by the method of the present disclosure. For example, the environment may be any of a railway station, a railway platform, a railway track, a railway line, or any part of a railway station, or airport, or bus station, etc. It will be appreciated that that method for automated safety management is explained in terms of a railway environment (for example, a railway station or a railway track). However, the method may be utilised interchangeably in any other type of working environment without any limitations.

The method comprises receiving monitored data from a monitoring apparatus, wherein the monitored data comprises at least one or more image frames associated with the environment. The term “monitored data” as used herein refers to surveillance information or data i.e., captured, monitored or generated via the monitoring apparatus. The monitored data is associated with the environment being managed by the method for safety management, wherein the monitored data comprises information or data such as, multiple image frames, or image frames, or other sensory information associated with the environment and elements (or objects) therein captured via the monitoring apparatus. In some examples, the monitored data comprises video data or image frames associated with a platform of a railway station i.e., the environment, wherein the monitored data may be a live video feed, captured video or image frames, or captured image frames, and other sensory information. Optionally, the monitored data comprises characteristic information associated with the environment and the elements therein, for example, information associated with fixed objects (that are part of the environment), or information associated with an operational vehicle (for example, a railroad car, railcar, railway wagon, railway carriage, railway truck, rail wagon, rail carriage or rail truck, etc.). Beneficially, the characteristic information enables the method to effectively monitor the environment and safety management thereof. The monitored data comprises the one or more image frames captured at different instances of time. In other words, the monitored data comprises a sequence of the image frames. In this regard, “image frames” refers to the sequence of images captured by a camera which may be viewed consecutively as a video. An image frame refers to one image captured by a camera, wherein the image may also be referred to as a “image frame” or a “sequence frame”. Optionally, the image frames are generated by creating a wrapper to extract the image frames from the one or more images forming the video. In this regard, a software, such as FFmpeg may be used for processing the video, wherein the video captured from the monitoring apparatus is split into several image frames.

The term “monitoring apparatus” as used herein refers to a structure and/or module that includes software, hardware and/or firmware components configured to store, process and/or share information and/or signals for monitoring the environment. Herein, the monitoring of the environment includes capturing image data and/or sensory data of elements within the environment via the monitoring apparatus. Typically, the monitoring apparatus comprises a combination of imaging devices and/or sensors arranged in a defined manner to effectively monitor the entire environment or at least a required part thereof. The monitoring apparatus comprises multiple sensors, scanners, cameras, and other monitoring devices that may be installed throughout the environment or associated with elements (or objects) therein for enabling safety management via the method. In an exemplary scenario of a railway platform having a train residing thereon, the train comprising six cabins having two doors each, the monitoring apparatus may comprise of 24 cameras i.e., 2 cameras for each door of the train, and 6 motion sensors i.e., 1 motion sensor for each cabin of the train. It will be appreciated by a person skilled in the art that any number of sensors, scanners, cameras, or other devices may be used in the monitoring apparatus for complete and accurate monitoring of the environment without any limitations.

In some embodiments, the monitoring apparatus comprises at least one of:
a camera arrangement, comprising:
   at least one first overwatch camera configured for capturing high-angle image frames of at least a part of the environment;
   at least one second bird-eye camera configured for capturing side angle image frames of at least a part of the environment;
   at least one third vehicular camera for capturing multi angled image frames of a vehicle; and
a sensor arrangement for capturing sensory information associated with the one or more objects in the environment.

The term “camera arrangement” as used herein refers to a set of cameras placed across different locations of the environment for capturing and thereby providing the one or more image frames of the environment, wherein the arrangement of the cameras provide different fields of view for effective and accurate management of the entire environment via the method. In an example, for monitoring a 400 m long railway station comprising four equidistant platforms, the camera arrangement comprises 16 cameras to effectively monitor the area i.e., four cameras for each platform. In this embodiment, to improve the efficiency of the method while maintaining the effectiveness and accuracy thereof, the monitoring apparatus may employ four cameras for each zone or platform in the environment. However, it will be appreciated that more or less cameras may be installed at different locations therein to enable efficient and effective safety management via the method.

The term “camera” as user herein refers to a device configured to capture the one or more images (or video) frames of the environment. The cameras employed in the camera arrangement are selected and located in a manner to enable capturing of high-quality (i.e., high resolution) image or image frames. Further, correct capturing of the monitored data or the one or more image frames therein depends on attributes associated with the cameras of the camera arrangement. The attributes associated with the cameras may be, depth of field of view, motion blur, shutter speed, aperture, distortion of lens, resolution, focal length, frames per second (FPS) and so forth. In an embodiment, the camera arrangement comprises at least one of: a visible-light camera, a stereo camera, a digital camera, a closed-circuit television (CCTV) camera, a dome camera, a bullet camera, a box camera, a Pan, Tilt and Zoom (PTZ) camera, a Red-Green-Blue (RGB) camera, a RGB-Depth (RGB-D) camera, a monochrome camera, an infrared-light camera, a depth camera, a ranging camera, a Time-of-Flight (ToF) camera, a Sound Navigation and Ranging (SONAR) camera, a LIDAR scanner, a Radar scanner, and a laser rangefinder. and the like. Beneficially, the camera arrangement is configured to provide high quality and/or resolution images of the environment to enable the system and/or the method to further differentiate and classify or detect elements therein to effectively manage the environment (for example, in a congested scene) with a high accuracy and/or precision. Additionally, the monitoring apparatus may be complimented by one or more machine learning models based on deep neural networks (DNN) configured to provide higher quality images with lower number of disturbances such as, but not limited to, vehicular headlights, shadows and/or glares from the image frames to improve mobility, safety and efficacy of the system and/or method. Advantageously, the image frames are captured to get a clear view of the railway environment. Herein, the railway environment comprises, but is not limited to, a railway station, at least one platform, railway track, a station building, passengers occasionally boarding or leaving the rail vehicle, signs, vegetation, overhead lines.

Notably, to effectively monitor the entire environment and the elements therein (such as, moving objects or fixed objects), the monitoring apparatus comprises different types of cameras to exploit the inherent advantages of the camera types to produce high quality images that enable the system to effectively and accurately perform the safety management operation.

In some embodiments, the camera arrangement comprises at least one first camera configured for capturing high-angle image frames of at least a part of the environment. The at least one first camera is configured for capturing high angled image frames of the environment to provide a lateral field of view of the environment, or capturing high-angle image frames of a part of the environment i.e., to provide granular control over the safety management operation via the method. Herein, the at least one first camera may be configured for a selected part (for example, a specific zone or platform) of the environment, or for the entire environment for general management via the method. Notably, the high angle of the high angle image frames may lie between 0 degrees to 90 degrees to provide a wide field of view. For example, the at least one first camera is an overwatch sensor or camera configured for capturing the one or more high-angle image frames. In an exemplary railway environment of a railway station having two platforms, platform A and platform B, the at least one first camera may be located in a manner so as to capture high angle image frames of each platform A and B, either separately or collectively.

In some embodiments, the camera arrangement further comprises at least one second camera configured for capturing side angle image frames of at least a part of the environment. Herein, to cover a separate field of view and thereby enable complete coverage of the environment, the side angle image frames i.e., another point of view from the high angle image frames, may be captured via the at least one second camera. Further, either collectively, or separately, each of the high angle image frames and the side angle image frames may be utilised to form the one or more images from the environment i.e., ultimately utilised via the method for automated safety management of the environment. For example, the at least one second camera may be a bird's eye view camera located on multiple sides of the environment to provide side-angle image frames thereof. In another example, the at least one second camera is installed on the sides of trains to look and capture images down the platform to detect trapped objects/people or people entering the gap between the train and the platform.

In some embodiments, the camera arrangement further comprises at least one third camera for capturing multi angled image frames of an operational vehicle in the environment. Typically, to enable detection of an operational vehicle entering in the environment, for example, a rail vehicle entering a platform in a railway environment, the camera arrangement further comprises the at least one third camera configured for capturing multi-angle image frames of the operational vehicle in the environment i.e., image frames from different fields of view to enable detection of the operational vehicle in the environment accurately. The camera arrangement may include the at least one third camera mounted on the operational vehicle (such as, a rail vehicle in a railway environment, an aeroplane in an airport environment, or on any operational vehicle), or a part thereof, in a manner so that the environment is in the field of view of the camera. In this regard, it is feasible to mount the camera in multiple locations of the environment to cover different fields of view thereof. Notably, the at least one third camera may be installed at an entrance (or exit) of the environment, or located at (or near) the front (or back) of the operational vehicle. For example, the at least one third camera may be installed at the head (or tail) of a train, or installed at an entrance (or exit) of a railway station.

In some embodiments, the monitoring apparatus further comprises a sensor arrangement for capturing sensory information associated with the one or more objects in the environment. The “sensor arrangement” refers to a group of sensors, usually deployed in a certain geometry pattern, used for collecting and processing electromagnetic or acoustic signals. The term “acoustic signals” herein refers to the signals carried by sound waves (mechanical waves) that travel through a medium such as air, water, or solid materials. Acoustic signals result from the compression and rarefaction of the medium's particles. The term “electromagnetic signals” herein refers to the signals (waves), comprised of oscillating electric and magnetic fields that are mutually perpendicular to each other and propagate in a direction perpendicular to both electric and magnetic fields. Optionally, electromagnetic sensors are employed for collecting and processing electromagnetic signals and are used to detect the position of objects through the analysis of the electromagnetic signals. Optionally, acoustic sensors are employed for collecting and processing acoustic signals and are used to capture sound waves generated by objects, enabling the detection of one or more objects in the environment. The sensors used in the sensor arrangement may be at least one of, but not limited to, position sensors, motion sensors, accelerometers, proximity sensors, and other localization sensors that may be configured to provide sensory information associated with the one or more objects enabling detection thereof. The position sensors are configured for detecting the position of objects or changes in position. The motion sensors are configured for detecting the motion or movement of objects. The accelerometers are configured for detecting the vibrations and changes in acceleration. The proximity sensors are used for detecting the presence or absence of objects within a certain range.

The method further comprises generating a plurality of point clouds by utilizing the one or more image frames in the monitored data associated with the environment. Alternatively stated, the one or more image frames of the environment received as part of the monitored data are processed to convert the two-dimensional (2-D) image frames into three-dimensional (3-D) point clouds for accurate and effective safety management via the method i.e., the one or more images frames in the monitored data are utilised or processed for generating the plurality of 3-D point clouds associated therewith.

The term “point cloud” refers to a set of data points in space i.e., a visual 3-D representation of the data points in the monitored data (or image frames). Alternatively stated, A point cloud is a visualisation made up of a set of points in space, wherein the points may represent objects. An object may be visualised as a one-dimensional (1D) object, or as a two-dimensional object (2D), or as a three-dimensional (3D) object. Herein, a given point is made up of a corresponding set of Cartesian coordinates (i.e., X, Y and Z coordinates). Advantageously, the point cloud can provide a representation of the 3D object in high-resolution, without distortion. Furthermore, the point cloud may be composed of points measured on the external surface of the objects present in the image frames. It will be appreciated that any conventional photogrammetry means may be employed by the method to generate the plurality of point clouds based on the one or more image frames of the method without any limitations. The photogrammetric analysis via the method may be applied to at least one of the one or more image frames, or may use high-speed photography and remote sensing to detect, measure and record complex 2D and 3D motion fields by feeding measurements and imagery analysis into computational models to estimate the actual 3D relative motions accurately.

Optionally, the step of generating the plurality of point clouds using the one or more image frames comprises employing at least one computer vision technique. In an embodiment, in case a given camera that captures 2D images is used, the point cloud can be generated using a Structure from Motion (SfM) technique, wherein a SfM technique can be wrapped using the OpenSfM library. In this regard, a Structure from Motion (SfM) technique is employed. The OpenSfM library is used to generate the point clouds from the image frames, wherein the given point cloud corresponds to a given set of image frames. The OpenSfM library can be used to find relative positions of objects in the image frames and to help create smooth transitions between the image frames, by matching the points between the image frames, and then determining 3D positions of those points in the point cloud. In an embodiment, in case the given camera that captures 3D data is used, then the point clouds are generated by processing the 3D data.

The method further comprises detecting one or more objects from the plurality of point clouds based on predefined notations. Alternatively stated, the method utilises the predefined notations to enable the method to detect the one or more objects from the plurality of point clouds through image processing based on the predefined notations, wherein the predefined notations are based on characteristic features of each of the one or more object types. The term “predefined notations” refer to classifications of a variety of object types pre-defined in various formats for easily classifying the one or more objects in the environment. For example, predefined (or open) object libraries or indexes such as, OpenCV®, or custom-defined private libraries. The notations may also be referred to as classifications or labels provided to the one or more objects to enable formation of annotated image frames required for training a machine learning algorithm to detect the one or more objects in the environment. Typically, the predefined notations are based on characteristic features of the one or more objects that enable distinction and identification thereof, wherein the characteristic features include, but are not limited to, an object location indicative of a current location, an object geometry indicative of dimensions or shape of the object, an object action indicative of a current action being performed by the object, an object type indicative of the kind or class of the object, and an object index. The term “object index” refers to object libraries having built-in configurations for different types of objects associated with the environment. For example, a railway object index comprises pre-identified railway objects such as, movable objects such as, machines or vehicles, or fixed objects such as, sign boards, walls, corridors, platform edges, vegetation, power lines, and the like.

In some embodiments, detecting the one or more objects from the plurality of point clouds comprises detecting the one or more objects from the plurality of point clouds comprises:
processing the plurality of point clouds via a segmentation module to segment the plurality of point clouds into a plurality of segmented point clouds;
classifying the plurality of segmented point clouds based on the predefined notations to detect the one or more objects; and
localizing the one or more objects, in the environment based on the predefined notations, wherein the predefined notations are based on at least one of an object location, an object geometry, an object action, an object type, and an object library.

In some embodiments, detecting the one or more objects from the plurality of point clouds comprises processing the plurality of point clouds via a segmentation module to segment the plurality of point clouds into a plurality of segmented point clouds. The term “segmentation module” refers to a module configured for segmentation of the plurality of point clouds into segmented point clouds. Beneficially, the segmentation module contributes to greater accuracy in object detection and classification, offering reliable results. Alternatively stated, the process of classifying point clouds into multiple homogeneous regions is done via the segmentation module, wherein the points in the same region or segmented point cloud will have the same properties. Beneficially, this leads to improved accuracy in object detection and classification, as the segmentation module allows for the precise classification of point clouds into homogeneous regions, ensuring that points with similar properties or characteristics are grouped together. Segmenting point clouds into regions of similar properties reduces the complexity of the data, making it more manageable and easier to process. Moreover, the process of classifying point clouds into multiple homogeneous regions reduces the chances of misclassification and facilitates more reliable analysis. This efficiency in data processing results in faster analysis and decision-making, which is particularly valuable in real-time applications. The term “segmented point clouds” refers to homogenous regions of the point cloud exhibiting similar properties or characteristics. Suitably, semantic segmentation via the segmentation module involves treatment of multiple objects of the same class as a single entity. Typically, the plurality of point clouds generated using the one or more image frames are made up of points that are rendered as pixels, and each pixel of the one or more image frames is assigned a label from a predefined set of classes using semantic segmentation, such as vegetation, railway track, railway vehicle, persons, signs and so forth. It will be appreciated that each pixel can represent a part of an object that can be notated or classified into a class and the object is identifiable unambiguously. Herein, the “label” indicates a type of object, such as trees, rail car units, buildings, signals etc.

Optionally, segmentation technique is used to classify pixels in the images. Optionally, the segmentation technique is employed to achieve more precise object localization within a reference frame. Optionally, the segmentation technique is employed to capture all the desired points of any object in the image which is imperative for accurate height measurement of the object. In some embodiments, the detection of one or more objects via the segmentation module facilitates the discernment of pixel values within imagery. This in turn, culminates in the precise quantification of object heights utilizing point cloud data. Notably, point clouds (which provides the real measurement values) obtained from the depth camera, are used to calculate the height of the object. These point clouds are then matched with the segmentation points. Consequently, the segmented points are calculated via the algorithm, thereby enabling to calculate the exact distance from any point on the object to the camera. Optionally, the segmentation module is further trained to enhance the classification of pixel coordinates (segmentation points) for different objects in order to have accurate measurement of height of the object.

In some embodiments, detecting the one or more objects from the plurality of point clouds further comprises classifying the plurality of segmented point clouds based on the predefined notations to detect the one or more objects, wherein the predefined notations are based on at least one of an object location, an object geometry, an object action, an object type, and an object library. Alternatively stated, upon segmenting the plurality of point clouds via the segmentation module, the method further comprises classifying the segmented point clouds (i.e., the homogeneous regions) in the environment based on the predefined notations, wherein the predefined notations are based on at least one of an object location, an object geometry, an object action, an object type, and an object library.

In a first approach, each pixel is classified individually disregarding the label assigned to the other pixels of the one or more image frames. Beneficially, this approach provides a high level of granularity, allowing for precise classification of the objects from the plurality of point clouds. Beneficially, such a classification paradigm aids in discerning the presence of any pertinent objects that need to be identified. In a second approach, each pixel is classified based on labels of its neighbouring pixels. Beneficially, this approach considers the context of neighbouring pixels when assigning labels, which leads to smoother and more coherent object detection. In a third approach, each pixel of the one or more image frames is labelled jointly by defining a class regarding the pixels, therefore generating the annotated image frames. In a third approach, using segmented module and point clouds data, we can have real measurement of any object from the camera. Subsequently, upon labelling the pixels in the one or more image frames, an annotated image or video frame is generated. For example, an image frame may comprise a railway track, vegetation, sign, sky. The image frame may be composed of 1000 pixels. Subsequently, upon semantic segmentation, 250 pixels of the image frame may be attributed as railway track, 250 pixels of the image frame may be attributed as vegetation, 100 pixels of the image frame may be attributed as sign, and 400 pixels of the image frame may be attributed as sky, thereby generating an annotated image frame version of the image frame.

In an exemplary embodiment, the first approach is employed to classify the instance of the train, wherein the instance can be door open, door closed, or object stuck in the door. Significantly, this approach provides with an indication to determine if there is any object obstructing the door's path or not.

In another exemplary embodiment, the second approach is employed to detect different classes of objects. Herein, one or more number of objects are classified and localised using the machine learning algorithms. Beneficially, by using the second approach, a safety measurement technique is designed for example, to identify how far is the distance of the stuck object from the door of the train. This provides with an indication to see if the situation is critical or not. Furthermore, a second machine learning algorithm is designed to identify any object instead of classifying only one or more objects from the plurality of point clouds.

In another exemplary embodiment, the third approach is employed by means of point cloud and object segmentation to localise all the object points and measure the corresponding desired height of the object.

In some embodiments, detecting the one or more objects from the plurality of point clouds further comprises localizing the one or more objects, in the environment based on the predefined notations. Upon classifying the plurality of point clouds to identify the one or more objects, the method further comprises localizing the one or more objects in the one or one or more images frames and their corresponding plurality of point clouds by assigning an address to each object, wherein the assignment may be based on any conventional assignment or localization means. Beneficially, the segmentation, classification and localization of the one or more objects in the environment further enable the method to accurately and efficiently detect each of the one or more objects in the environment and thereby enable the method to effectively monitor and safely manage the environment.

Optionally, localising the one or more objects may comprise:
detecting the one or more objects in the one or more image frames and their corresponding plurality of point clouds, and drawing a bounding box in the one or more image frames, wherein the bounding box may be fitted to the one or more objects; and
associating the labels attributed to pixels of the one or more image frames to corresponding points within the plurality of point clouds.

Herein, a given bounding box is defined by ‘x’ and ‘y’ coordinates of its vertices to describe a spatial location of its corresponding object in a given image frame. In this regard, object detection models may be used to detect the railway track in the annotated image frames and their corresponding point clouds. Object detection models are well-known in the art. The ‘x’ and ‘y’ coordinates of the bounding box help determine location of the railway track. The labels attributed to the pixels of the annotated image frames enable a given object to spatially associate with respect to other objects in the railway environment.

Optionally, the method may comprise training the segmentation module using a machine learning algorithm, wherein upon training, the segmentation module learns to perform the step of attributing the labels to each pixel of the one or more image frames for generating the annotated image frames. Beneficially, training the segmentation module significantly reduces the need for manual annotation of every pixel in image frames thereby saving time and effort. Moreover, training the segmentation module using machine learning algorithms, are crucial for accurate object detection and segmentation in real-world scenarios. The segmentation module may be a deep learning model or a neural network such as, a convolutional neural network. The training of the segmentation module is performed using reference images of the environment. Herein, the reference images are annotated and then used for training of the segmentation module, wherein the annotated reference images depict objects such as trees, buildings, vehicles, people and so forth, in said environment. The machine learning algorithm may be, but not limited to, a clustering-based segmentation algorithm, a neural-network-based segmentation algorithm, and so forth. The image segmentation model can be a deep learning model that is trained to determine the objects present in the environment and also assign the same label to the pixels corresponding to a given object in the one or more image frames during detection.

The method further comprises detecting at least one target object from the one or more objects based on at least a risk criterion. Upon detecting the one or more objects in the environment, the method further comprises identifying or detecting the at least one target object therefrom based on a risk criterion. Herein, each of the one or more objects may be processed via video analytics performed via the method to detect the at least one target object i.e., an object of the one or more objects deemed high risk based on the risk criterion. Typically, the environment during operation is frequented with risky events that deem a risk on the object or the environment. In an exemplary scenario, objects moving beyond the environment or a boundary therein, for example, a platform boundary, and objects dwelling beyond the boundary for an abnormal period of time may be referred to as target object wherein the action or violation enacted by the target object is deemed as the target event. Thus, a need for identifying such risky objects i.e., the at least one target object that may cause an associated target event i.e., a violation of rules associated with the environment that presents a physical risk to the object is fulfilled via the method for automated safety management.

The term “risk criterion” as used herein refers to a criterion or a set of rules based on which an object is deemed to be a risk. The risk criterion may comprise a list of rules, target events, or violations that are required to be prevented by the safety management method of the present disclosure. Herein, the risk criterion may refer to a set of predefined rules that describe the violation conditions. In case any one of the set of predefined rules of the risk criterion are satisfied, it signifies that a target event condition has been met. For example, in case any obstruction is detected in the surroundings of a railway track (in particular, of the bounding box), the obstruction results in a violation condition being met with respect to the bounding box.

The term “target event” as used herein refers to risky events, violations, or improper actions associated with the user that are required to be identified for proper safety management via the method. In an example, the target event comprises events wherein objects move beyond the environment or a permitted boundary therein, for example, a platform edge or a platform safety line. In another example, the target event comprises events wherein objects dwell beyond the boundary for an abnormal period of time.

In some embodiments, detecting the at least one target object based on the risk criterion comprises identifying objects, from the one or more objects, that are:
located in a restricted zone,
located within a safety limit,
dwelling for a period greater than a predefined time period,
obstructing other objects or hindering operation, or
encroaching any other pre-defined digital boundary.

Optionally, detecting the at least one target object based on the risk criterion comprises identifying objects, from the one or more objects, that are located in a restricted zone i.e., unauthorized for access by any authorized person or passenger. For example, railway track or control room.

Optionally, detecting the at least one target object based on the risk criterion comprises identifying objects, from the one or more objects, that are located within a safety limit. For example, the safety limit may be a distance from a boundary or zone, such as, a minimum safety distance to be maintained from a platform edge to prevent any unwanted accidents such as, passengers breaching the safety limit and getting caught in velocity envelope of a train.

Optionally, detecting the at least one target object based on the risk criterion comprises identifying objects, from the one or more objects, that are dwelling for a period greater than a predefined time period. In cases, wherein objects remain within the environment or a part thereof for long periods of times, such as, at unauthorized or risky areas and may potentially cause a violation or an unforeseen event or accident. Herein, the predefined time period refers to a pre-set period of time depending upon the type of risk or target event, wherein the predefined time period may range from a few seconds to multiple hours or days. In an example, a person staying within the environment for 2 consecutive days. In another example, a person entering a railway track and not leaving it within 15 seconds.

Optionally, detecting the at least one target object based on the risk criterion comprises identifying objects, from the one or more objects, that are obstructing other objects or hindering operation of the environment or the objects therein. In some cases, the objects may prevent other objects such as, automatic doors, trains from functioning properly such as, an object obstructing the closing of a door of a train, before which the train cannot begin its journey, or an object preventing other persons from accessing the train or train door.

Optionally, detecting the at least one target object based on the risk criterion comprises identifying objects, from the one or more objects, that are encroaching any other pre-defined digital boundary. To provide greater granular control and management of different parts of the environment, the method further comprises defining a digital boundary that enables the method to determine the at least one target object and/or target events associated therewith. The “digital boundary” as used herein refers to a virtual boundary within the environment beyond which access is unauthorized by other objects or persons. For example, a railway station boundary, a platform boundary, a railway track boundary, a power line boundary, and so forth to prevent unauthorized access and potential mishaps from taking place and enabling effective safety management via the method.

Optionally, the annotated image frames and their corresponding points are thoroughly examined to determine the presence of at least one target event associated with the at least one target object present in the railway environment, as the annotated image frame may be a completely normal image. The term “violation” encompasses one or more of: presence of a non-compliant asset that does not comply with industry standards in the environment such as, hazardous working conditions in a railway environment, unwanted obstructions or objects along the railway track. In an embodiment, the step of evaluating the annotated image frames and their corresponding point clouds using the at least one predefined rule is performed to also determine whether or not passengers (or objects) are present in the environment. When it is detected that passengers are present in the environment, the method may further comprise counting a number of the passengers.

Optionally, when the environment is a railway environment, the risk criterion may comprise at least one geometric rule and/or at least one custom-defined rule. The risk criterion may comprise at least one of:
determining that a high lineside violation may be present when vegetation is present in a first space that is defined by two planes extending obliquely within a predefined distance from two rails of a railway track,
determining that an overhead vegetation violation may be present when vegetation is present in a second space lying vertically above the railway track;
determining that a sign violation may be present when a given sign in the railway environment is at least one of: obscured by another object, unreadable, vandalised;
determining that a signal violation may be present when a given signal in the railway environment is at least one of: obscured by another object, malfunctioning, vandalised;
determining that a safe cess violation may be present when a cess adjacent to the railway track is obstructed at least partially such that a distance between a non-obstructed region of the cess and the railway track is less than a predefined safety distance;
determining that a scrap violation may be present when scrap is present on or in proximity of the railway track; and
determining that a graffiti violation may be present when graffiti is detected within the environment.

In this regard, the at least one geometric rule may depend on a perspective of the at least one camera while capturing the first video of the railway environment. The at least one geometric rule may depend on position, colour or brightness (i.e., in case a monochrome camera is used) of each pixel of the image frames. The custom-defined rule may be manually defined by the user, or may be automatically generated by the system, or may be a combination of both.

Optionally, the high lineside violation occurs when any unwanted object is too close to the railway tracks. The first space is a space lying in close proximity to the railway track, and when any unwanted object is present in the first space, the high lineside violation occurs. An extent of the first space is defined by the two planes and the predefined distance. An angle between a given plane corresponding to a given rail and a ground surface lies within a range of 30 degrees to 60 degrees. As an example, the angle between a given plane corresponding to a given rail and a ground surface may be 45 degrees. The angle between the given plane corresponding to the given rail and the ground surface may be in a range of from 30 to 40 degrees, or from 30 to 50 degrees, or from 30 to 60 degrees, or from 40 to 50 degrees, or from 40 to 60 degrees, or from 50 to 60 degrees. Correspondingly, an angle between a rail vehicle and the given plane may lie within a range of 60 degrees to 30 degrees. A high lineside violation occurs when an object in the latter space between a plane and a rail vehicle.

Optionally, the predefined distance may lie in a range of 0 to 5 metres. The predefined distance may be in a range of from 0 to 3 metres, or from 0 to 4 metres, or from 0 to 5 metres, or from 1 to 4 metres, or from 3 to 5 metres, or from 4 to 5 metres. For example, the predefined distance may be 2 metres. In another case, a first object is at a distance of 0.5 metres from the railway track, then the high lineside violation may occur. However, when a second object is at a distance of 2.5 metres from the railway track, then the high lineside violation may not occur.

Optionally, a given image frame comprises a pixel representation of the vegetation and a pixel representation of the railway track. Subsequently, the given image frame and the corresponding point cloud are used to determine the spatial relationship between the pixel representation of the vegetation and the pixel representation of the railway track, wherein the pixel representation of the vegetation is determined to spatially lie above the pixel representation of the railway track. Therefore, the overhead vegetation violation may occur.

Optionally, the sign violation may be determined when size of the given sign is less than expected in the image frame, or the given sign is not visible in the image frame, or visual detail of the given sign is incomprehensible, or similar. Herein, size and location of the signs may be pre-known. The given sign is deemed unreadable due to weathering or vandalization, upon comparing the given sign with reference images of the given sign.

Optionally, signal violation may be determined when a given signal is not visible in the image frame, or the given signal looks different (from an expected appearance) when compared to the reference images related to a functioning signal. The given signal may not be visible in the image frame, or visual detail of the given signal is incomprehensible, or similar. Herein, size, location and function of the given signal may be pre-known.

The safe cess can optionally be understood to be a virtual tunnel (i.e., a virtually-defined space) adjacent to the railway track which ideally should be clear of obstructions, such as vegetation, ballast bags, structures and so forth. The safe cess allows track workers to safely transit the railway environment at a predefined safety distance from the railway track. The safe cess violation is undesirable as it puts the track workers at risk of being too close to the railway track, which could lead to injury or loss of life. A distance between the non-obstructed region of the cess and the railway track can be determined by the pixels in the image frames and their corresponding point clouds.

Optionally, the scrap may consist of unused railway assets such as, but not limited to, sleepers, fixtures, fish plates, condemned coaches, wagons and so forth. Presence of the scrap on or in proximity of the railway track endangers the safe functioning of the rail vehicle.

Optionally, the predefined safety distance may depend on a maximum speed at which the rail vehicle is permitted to run on the railway track, and wherein:
the predefined safety distance may lie in a range of 2 metres to 2.75 metres when the maximum speed is equal to or greater than 100 miles per hour; and
the predefined safety distance may lie in a range of 1.25 metres to 2 metres when the maximum speed is less than 100 miles per hour.

In this regard, the greater the maximum speed at which the rail vehicle is permitted to run on the railway track, the higher the predefined safety distance. The predefined safety distance may be in a range of from 2 to 2.50 metres, or from 2 to 2.75 metres, or from 2.25 to 2.75 metres, when the maximum speed is equal to or greater than 100 miles per hour. The predefined safety may be in a range of from 1.25 to 1.75 metres, or from 1.25 to 2 metres, or from 1.50 to 2 metres. As a first example, when the maximum speed is equal to or greater than 100 miles per hour, then the track workers should be at least 2.4 metres away from the given rail of the railway track. Conversely, when the maximum speed is less than 100 miles per hour, the track workers should be at least 1.30 metres away from the given rail of the railway track.

The method further comprises generating a command signal indicative of a risk event associated with the at least one target object.

The term “command signal” as used herein refers to a type of signal comprising information associated with the at least one target object and the target event associated therewith. For example, the command signal may be one of an auditory signal, or a textual alert, indicating the presence of the target event (for example, a safety violation) associated with the at least one target object.

In some embodiments, generating the command signal comprises at least one of:
generating an event data comprising information associated with the at least one target object; and
providing the event data with one or more of a visual alert, a textual alert, an audible alert, or an audio-visual alert indicative of the risk event associated with the at least one target object.

The term “event data” as used herein refers to information associated with the at least one target object and/or the associated target event, that enable verification and/or review of the method and operations performed therein by an external entity, such as, a safety authority, or a control room associated with the environment. For example, the event data may comprise annotated image frames converted from the one or more image frames of the environment, other characteristic information associated with the at least one target object and/or the target event. It will be appreciated that the event data may be further utilised for training of a neural network to perform the safety management of the environment in a dynamic and effective manner.

Optionally, the event data may be in form of at least one of:
an annotated image representing one or more of the at least one target object and the target event associated therewith, and its bounding box;
a file including at least one property of the at least one target object or the target event associated therewith, wherein the at least one property is at least one of: a type, a location, a size, a time-point of occurrence in the one or more images frames, of the at least one target object and/or the target event.

In this regard, the annotated image labels the objects which represent the at least one target object that helps to recognize the associated target event. Herein, the at least one target object and its bounding box may be annotated using text, annotation tools, or a combination of both, to show the objects that comprise the at least one violation. Herein, annotation of a given image representing the at least one target and the associated target event (for example, a violation) may be generated by at least one server or processor employed by the method. Additionally, a user may manually supplement annotations generated by the at least one server. The annotated image may be used to further develop rules for detecting violations. The file may also include metadata of the annotated image, such metadata including coordinates of the bounding box. The file may be of any suitable format, not limited to only a text file.

Upon generating the event data, the method further comprises providing the event data with one or more of a visual alert, a textual alert, an audible alert, or an audio-visual alert indicative of the risk event associated with the at least one target object. Typically, once the relevant target event is detected by the method, two categories of interventions may be delivered simultaneously via the method. In a first intervention or embodiment, the method for automated safety management is configured to generate an alert (i.e., the command signal) to prevent an unwanted operation. In an example, the command signal is transmitted to prevent an operational vehicle (such as a train) from performing unwanted operations (for example, departing from the platform). In a second embodiment, the method is configured to act as an auxiliary system configured to generate the command signal in the form of auditory signal, for example, audio alerts issued via onboarded train and/or a platform public announcement system for the relevant target event.

In an example, the target event is a “Trap and Drag” event, wherein the command signal is an audio: “please do not obstruct the doors”. In another example, the target event is a contact with a side of an operational vehicle or an object within the environment, for example, a train, a person, or an object, wherein the command signal is an audio: “please stand behind the yellow lines and stop leaning on the train”. In another example, the target event is a person entering a gap between a train and a platform, wherein given the potential severity of this type of incident, the command signal is transmitted to working personnel of the environment such as a staff member in the control room, who is notified and local station staff are requested to inspect the issue whilst the train is held at a platform.

In another example, the target event may be a person, such as a member of staff at the station or a member of the public, portraying a specific signal. The specific signal may include, for example, the person crossing their arms then tapping their head twice. Such a specific signal may be predefined as an emergency situation, wherein the person requires immediate assistance. The command signal may be transmitted to working personnel of the environment, who may then inspect the issue. Alternatively, the command signal may be transmitted directly to emergency services, such as, the police, who may then inspect the issue. Beneficially, the specific signal may be discrete such that the person can portray the specific signal and receive immediate assistance without any other person noticing.

The present disclosure also relates to a system for automated train-safety management system as described above. Various embodiments and variants disclosed above apply mutatis mutandis to the automated train-safety management system.

A second aspect of the invention provides an automated train-safety management system, the system comprising:
a monitoring apparatus configured for monitoring an environment and generating monitored data; and
at least one server, operatively coupled with the monitoring apparatus, the server is configured to:
   utilise the one or more image frames in the monitored data for generating a plurality of point clouds associated with the environment;
   detect one or more objects from the plurality of point clouds based on predefined notations;
   detect at least one target object from the one or more objects based on a risk criterion; and
generate a command signal indicative of a risk event associated with the at least one target object.

Throughout the present disclosure, the term “server” refers to a structure and/or module that includes programmable and/or non-programmable components configured to store, process and/or share information or data for automated safety management of the environment via the system. Herein, the server is configured to communicate with other elements within the system i.e., the monitoring apparatus, or other user devices, to securely and efficiently manage the environment via the system. Alternatively stated, the server is responsible for causing the bootstrapping operation via the method and configured to send commands, requests and messages to the connected elements i.e., the monitoring apparatus, wherein each element of the monitoring apparatus may perform the actions on their own, or on request, or command from the server. However, it will be appreciated that the server may be a part of the monitoring apparatus, or a separate or remote server to perform the safety management operations without any limitations.

Optionally, the server includes any arrangement of physical or virtual computational entities capable of enhancing information to perform various computational tasks. Furthermore, it will be appreciated that the server may be implemented as a hardware server and/or plurality of hardware servers operating in a parallel or in a distributed architecture. Optionally, the servers in the server are supplemented with additional computation systems, such as neural networks, and hierarchical clusters of pseudo-analog variable state machines implementing artificial intelligence algorithms. In an example, the server may include components such as a memory, a database, a processor, a data communication interface, a network adapter and the like, to store, process and/or share information with other computing devices, such as the monitoring apparatus. Optionally, the server is implemented as a computer program that provides various services (such as, database services) to other devices, modules or apparatus. Moreover, the server refers to a computational element that is operable to respond to and processes instructions to perform the for automated safety management of the environment via the system. For example, the server may be a cloud server, an application server, a file server, a database server or a block chain server. Optionally, the server includes, but is not limited to, a microprocessor, a microcontroller, a complex instruction set computing (CISC) microprocessor, a reduced instruction set (RISC) microprocessor, a very long instruction word (VLIW) microprocessor, Field Programmable Gate Array (FPGA) or any other type of processing circuit, for example as aforementioned. Additionally, the server is arranged in various architectures for responding to and processing the instructions for automated safety management of the environment via the system.

In some embodiments, the monitoring apparatus comprises at least one of:
a camera arrangement, comprising:
   at least one first camera configured for capturing high-angle image frames of at least a part of the environment;
   at least one second camera configured for capturing side angle image frames of at least a part of the environment;
   at least one third camera for capturing multi angled image frames of an operational vehicle in the environment; and
a sensor arrangement for capturing sensory information associated with the one or more objects in the environment.

Optionally, the system may further comprise a data repository communicably coupled to the server and/or the monitoring apparatus, wherein the data repository is configured to store at least one of: the one or more images frames, the plurality of point clouds generated using the image frames, labels attributed to each pixel of the image frames, a risk criterion comprising a set of predefined rules, inspection information, other relevant image frames. The term “data repository” refers to hardware, software, firmware, or a combination of these for storing a given information in an organized (namely, structured) manner, thereby, allowing for easy storage, access (namely, retrieval), updating and analysis of the given information. The data repository may be implemented as a memory of a device (such as the monitoring apparatus, or similar), a removable memory, a cloud-based database, or similar. The data repository can be implemented as one or more storage devices. A technical effect of using the data repository is that it provides an ease of storage and access of processing inputs, as well as processing outputs.

A third aspect of the invention provides a computer program product for automated safety management of an environment, the computer program product comprising a non-transitory machine-readable data storage medium having stored thereon program instructions that, when accessed by a processing device, cause the processing device to execute steps of a method of the first aspect. The term “computer program product” refers to a software product comprising program instructions that are recorded on the non-transitory machine-readable data storage medium, wherein the software product is executable upon a computing hardware for implementing the aforementioned steps of the method for automatic safety management of the environment.

In an embodiment, the non-transitory machine-readable data storage medium can direct a machine (such as computer, other programmable data processing apparatus, or other devices) to function in a particular manner, such that the program instructions stored in the non-transitory machine-readable data storage medium case a series of steps to implement the function specified in a flowchart corresponding to the instructions. Examples of the non-transitory machine-readable data storage medium includes, but is not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 is an illustration of a flowchart depicting steps of a method for automated safety management in an environment, in accordance with an embodiment of the present disclosure;

FIG. 2 is a block diagram representing an automated safety management system, in accordance with an embodiment of the present disclosure;

FIGS. 3A to 3C are exemplary environments for automated safety management via the method of FIG. 1 or the system of FIG. 2, in accordance with one or more embodiments of the present disclosure;

FIG. 4 is an exemplary railway environment, in accordance with an embodiment of the present disclosure;

FIG. 5 are exemplary violations in a railway environment, in accordance with an embodiment of the present disclosure; and

FIG. 6 is an exemplary safe cess in a railway environment, in accordance with an embodiment of the present disclosure.

### DETAILED DESCRIPTION

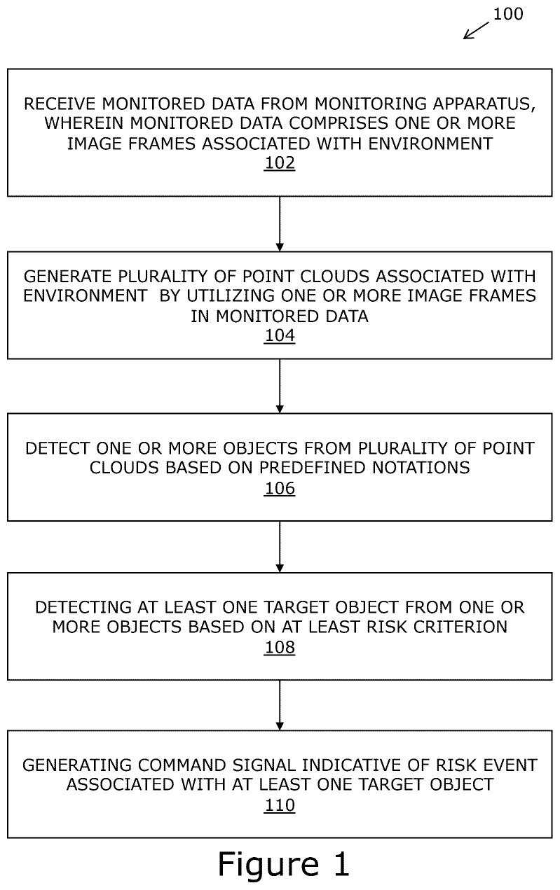

Referring to FIG. 1, illustrated is a flowchart listing steps involved in a method 100 for automated safety management in an environment, in accordance with an embodiment of the present disclosure. As shown, the method 100 comprising steps 102, 104, 106, 108 and 110.

At a step 102, the method 100 comprises receiving monitored data from a monitoring apparatus, wherein the monitored data comprises one or more image frames associated with the environment;

At a step 104, the method 100 further comprises generating a plurality of point clouds associated with the environment by utilizing the one or more image frames in the monitored data;

At a step 106, the method 100 further comprises detecting one or more objects from the plurality of point clouds based on predefined notations;

At a step 108, the method 100 further comprises detecting at least one target object from the one or more objects based on at least a risk criterion; and

At a step 110, the method further comprises generating a command signal indicative of a risk event associated with the at least one target object.

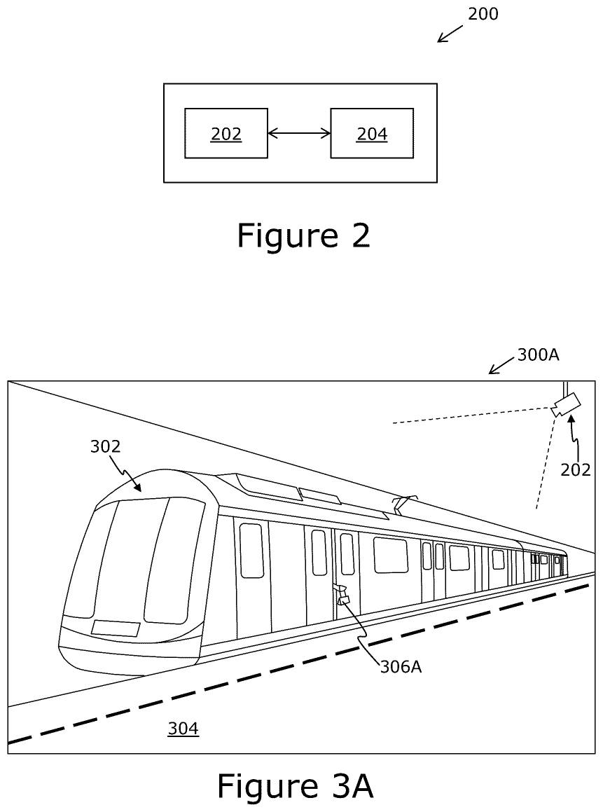

Referring to FIG. 2, illustrated is a block diagram of an automated train-safety management system 200, in accordance with another embodiment of the present disclosure. As shown, the system 200 comprises a monitoring apparatus 202 and a server 204. The monitoring apparatus 202 is configured for monitoring an environment and generating the monitored data. The system 200 further comprises the server, operatively coupled with the monitoring apparatus, wherein the server is configured to utilise the one or more image frames in the monitored data for generating a plurality of point clouds associated with the environment, detect one or more objects from the plurality of point clouds based on predefined notations, detect at least one target object from the one or more objects based on a risk criterion and generate a command signal indicative of a risk event associated with the at least one target object.

Optionally, in the system 200, the monitoring apparatus 202 comprises at least one of a camera arrangement and a sensor arrangement (not shown for simplification), wherein the camera arrangement 206 comprises at least one first camera configured for capturing high-angle image frames of at least a part of the environment, at least one second camera configured for capturing side angle image frames of at least a part of the environment, and at least one third camera for capturing multi angled image frames of an operational vehicle in the environment, and wherein, the sensor arrangement 208 configured for capturing sensory information associated with the one or more objects in the environment.

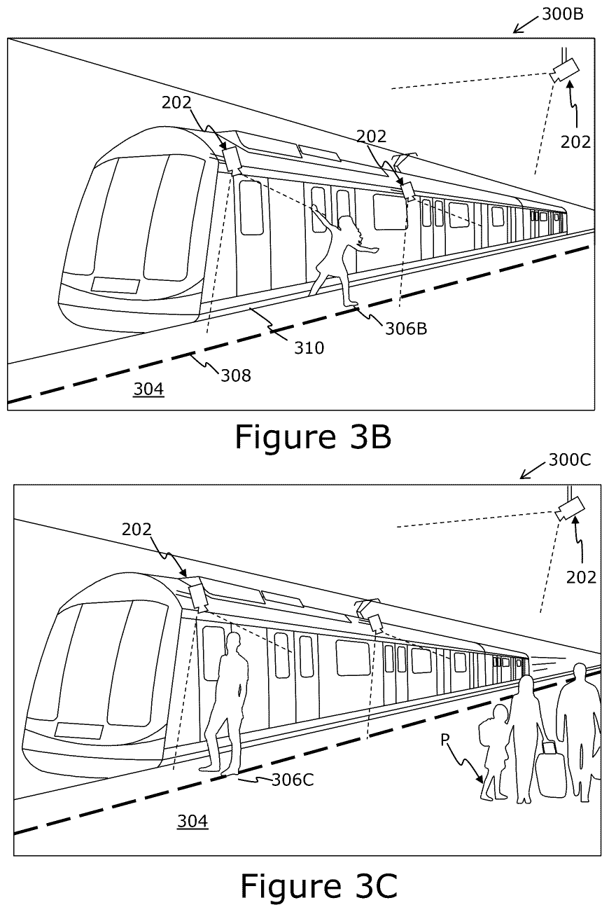

Referring to FIGS. 3A to 3E, illustrated are exemplary environments 300A to 300E, respectively, in accordance with one or more embodiments of the present disclosure. As shown, the railway environments 300A to 300E comprise an operational vehicle 302 (such as, a train or a railway vehicle) waiting on a platform 304 of the respective environment 300A to 300E. Further shown, the operational vehicle 304 and the one or more objects are identified and monitored via the method 100 or system 200 by utilizing the monitoring apparatus 202 to capture one or more image frames of the environment 300A and thereby the server 204 is configured to process the captured image frames to detect the one or more objects based on predefined notations. Further, upon detecting the one or more objects, the method further comprises detecting the at least one target object 306 from the one or more objects, wherein the at least one target 306A is associated with a target event.

Referring to FIG. 3A, illustrated is a first exemplary railway environment 300A, in accordance with an embodiment of the present disclosure. As shown, the railway environment 300A comprises an operational vehicle 302 (such as, a train or a railway vehicle) waiting on a platform 304 of the environment 300A. Further shown, the at least one target object 306A identified herein is a person's hand along with a handbag i.e., stuck in a door of the operational vehicle 302 and the associated target event is an obstruction on the door hindering operation thereof.

Referring to FIG. 3B, illustrated is a second exemplary railway environment 300B, in accordance with another embodiment of the present disclosure. As shown, the railway environment 300B comprises an operational vehicle 302 (such as, a train or a railway vehicle) waiting on a platform 304 of the environment 300B. Further shown, the platform comprises a safety limit 308 indicative of a permissible standing area for the passengers P. Herein, the at least one target object 306B detected is a person standing beyond the safety limit 308 and wherein the target event is the person's leg being stuck in a gap 310 between the platform 304 and the operational vehicle.

Referring to FIG. 3C, illustrated is a second exemplary railway environment 300C, in accordance with another embodiment of the present disclosure. As shown, the railway environment 300C comprises an operational vehicle 302 (such as, a train or a railway vehicle) waiting on a platform 304 of the environment 300B. Further shown, the platform comprises a safety limit 308 indicative of a permissible standing area for the passengers P. Herein, the at least one target object 306B detected is a person standing beyond the safety limit 308 and wherein the target event is the person standing beyond the safety limit 308 that may cause the person to be harmed on account of an incoming high-speed operational vehicle 302 i.e., getting caught in a velocity envelope thereof. FIGS. 3A to 3C are merely an example, which should not unduly limit the scope of the claims herein. A person skilled in the art will recognize many variations, alternatives, and modifications of embodiments of the present disclosure.

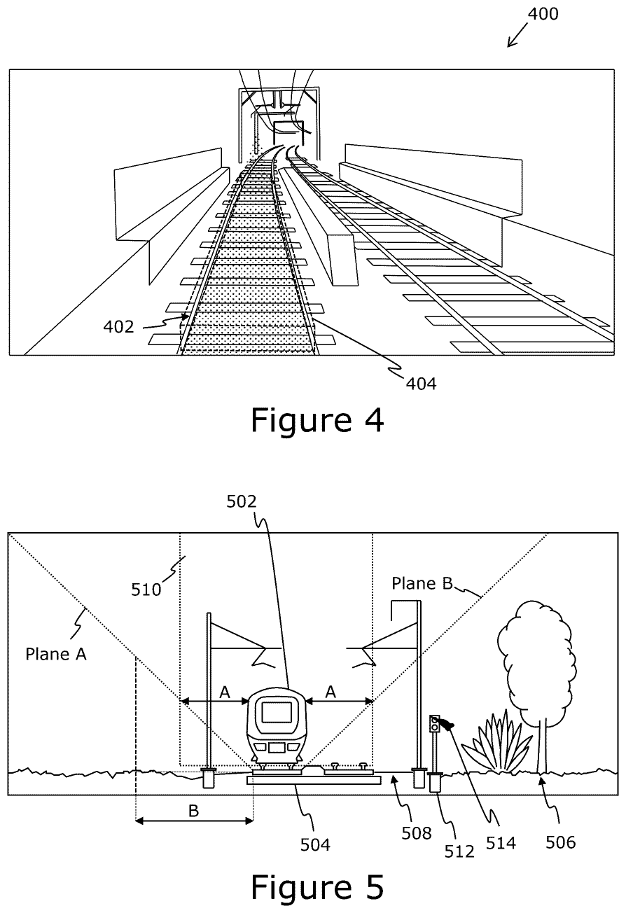

Referring to FIG. 4, there is shown an exemplary railway environment 400, in accordance with an embodiment of the present disclosure. The railway environment 400 comprises a railway track 402. The railway track 402 may be detected in annotated image frames and their corresponding point clouds, and a bounding box 404 may be drawn in the annotated image frames, wherein the bounding box 404 is fitted to the railway track 402. Subsequently, it is determined whether at least one violation is present in the railway environment 400 when violation conditions are satisfied in respect to the bounding box 404.

FIG. 4 is merely an example, which should not unduly limit the scope of the claims herein. A person skilled in the art will recognize many variations, alternatives, and modifications of embodiments of the present disclosure.

Referring to FIG. 5, there are shown exemplary violations in a railway environment, in accordance with an embodiment of the present disclosure. The violations may be high lineside violation, safe cess violation, overhead vegetation violation and so forth. The railway environment may comprise a rail vehicle 502, a railway track 504, vegetation 506 and a cess 508. Two planes, namely Plane A and Plane B extend obliquely from two rails of the railway track 504. The angle between the Plane A or Plane B corresponding to a given rail and a ground surface may be 45 degrees. Notably, any obstruction that may be present in a first space 510 (between the plane A and the rail vehicle 504) is detected as the high lineside violation. The first space 510 is defined by the two planes (Plane A and Plane B), and extends within a predefined distance from the two rails. The predefined distance may, for example, be equal to 2 metres.

In case any obstruction is present beyond the predefined distance (for example, at a distance of 6 metres (as denoted by line B) from the railway track 504 but inbetween the planes A and B, the obstruction is not detected as the high lineside violation but is detected as a reduced sign or signal visibility or the safe cess violation. Herein, when the cess 508 adjacent to the railway track 504 is obstructed at least partially such that a distance between a non-obstructed region of the cess 508 and the railway track 504 is less than a predefined safety distance, then an unsafe situation (i.e., accidents and so forth) is created for the track workers.

In this regard, a violation is not detected when vegetation 506 is present in the railway environment as shown in the figure. However, in case the vegetation 506 extends above the railway track 504, such as for example, branches of a tree present in the vegetation 506 extend in a manner that the branches lie above the railway track 504, an overhead vegetation violation would be detected.

Furthermore, the railway environment may comprise a signal 512. As an example, the signal 512 may be partially or fully obscured by an object 514. This results in a signal violation.

FIG. 5 is merely an example, which should not unduly limit the scope of the claims herein. A person skilled in the art will recognize many variations, alternatives, and modifications of embodiments of the present disclosure.

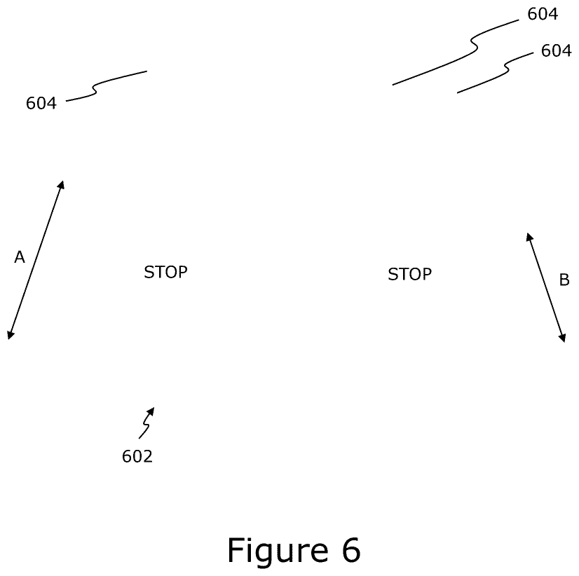

Referring to FIG. 6, there is shown an exemplary safe cess in a railway environment, in accordance with an embodiment of the present disclosure. A safe cess is adjacent to a railway track 602 in the railway environment. The safe cess allows track workers 604 to safely transit the railway environment at a predefined safe area which is at a predefined distance (depicted as A and B) from the railway track 602. The predefined safety distance depends on a maximum speed at which a rail vehicle is permitted to run on the railway track 602. Herein, the predefined safety area lies in a range of 2 metres to 2.75 metres when the maximum speed is equal to or greater than 100 miles per hour (depicted as the area above A). Furthermore, the predefined safety area lies in a range of 1.25 metres to 2 metres when the maximum speed is less than 100 miles per hour.

FIG. 6 is merely an example, which should not unduly limit the scope of the claims herein. A person skilled in the art will recognize many variations, alternatives, and modifications of embodiments of the present disclosure.

1-10. (canceled)

11. A method for automated safety management in an environment, the method comprising:
receiving monitored data from a monitoring apparatus, wherein the monitored data comprises one or more image frames associated with the environment;
generating a plurality of point clouds associated with the environment by utilizing the one or more image frames in the monitored data;
detecting one or more objects from the plurality of point clouds based on predefined notations;
detecting at least one target object from the one or more objects based on at least a risk criterion; and
generating a command signal indicative of a risk event associated with the at least one target object.

12. The method of claim 11, wherein the monitoring apparatus comprises at least one of:
a camera arrangement comprising:
at least one first camera configured for capturing high-angle image frames of at least a part of the environment;
at least one second camera configured for capturing side angle image frames of at least a part of the environment;
at least one third camera for capturing multi angled image frames of an operational vehicle in the environment; and
a sensor arrangement for capturing sensory information associated with the one or more objects in the environment.

13. The method of claim 11, wherein detecting the one or more objects from the plurality of point clouds comprises:
processing the plurality of point clouds via a segmentation module to segment the plurality of point clouds into a plurality of segmented point clouds;
classifying the plurality of segmented point clouds based on the predefined notations to identify the one or more objects, wherein the predefined notations are based on at least one of an object location, an object geometry, an object action, an object type, and an object library; and
localizing the one or more objects, in the environment based on the predefined notations to detect the one or more objects.

14. The method of claim 11, wherein detecting the at least one target object based on the risk criterion comprises identifying objects, from the one or more objects, that are:
located in a restricted zone,
located within a safety limit,
dwelling for a period greater than a predefined time period, obstructing other objects or hindering operation, or encroaching any other pre-defined digital boundary.

15. The method of claim 13, wherein the method comprises training the segmentation module using a machine learning algorithm, wherein upon training, the segmentation module learns to perform the step of attributing labels to each pixel of the one or more image frames for generating the annotated image frames.

16. The method of claim 13, wherein localising the one or more objects comprises:
detecting the one or more objects in the one or more image frames and their corresponding plurality of point clouds, and drawing a bounding box in the one or more image frames, wherein the bounding box is fitted to the one or more objects; and
associating the labels attributed to pixels of the one or more image frames to corresponding points within the plurality of point clouds.

17. The method of claim 11, wherein generating the command signal comprises at least one of:
generating an event data comprising information associated with the at least one target object; and
providing the event data with one or more of a visual alert, a textual alert, an audible alert, or an audio-visual alert for the risk event associated with the at least one target object.

18. An automated train-safety management system, the system comprising:
a monitoring apparatus configured for monitoring an environment and generating the monitored data; and
a server, operatively coupled with the monitoring apparatus, the server is configured to:
utilise the one or more image frames in the monitored data for generating a plurality of point clouds associated with the environment;
detect one or more objects from the plurality of point clouds based on predefined notations;
detect at least one target object from the one or more objects based on a risk criterion; and
generate a command signal indicative of a risk event associated with the at least one target object.

19. The system of claim 18, wherein the monitoring apparatus comprises at least one of:
a camera arrangement, comprising:
at least one first camera configured for capturing high-angle image frames of at least a part of the environment;
at least one second camera configured for capturing side angle image frames of at least a part of the environment;
at least one third camera for capturing multi angled image frames of an operational vehicle in the environment; and
a sensor arrangement for capturing sensory information associated with the one or more objects in the environment.
